(19) United States
(12) Patent Application Publication
(10) Pub. No.: US 2006/0088046 A1
(43) Pub. Date: Apr. 27, 2006

(54) Queue resource sharing for an input/output controller

(76) Inventors: Kar Leong Wong, Teluk Intan (MY); Mikal C. Hunsaker, El Dorado Hills, CA (US); Prasanna C. Shah, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/974,573

(22) Filed: Oct. 26, 2004

(51) Int. Cl. H04L 12/56

(52) U.S. Cl. 370/413

(57) ABSTRACT

Queue resource sharing for an input/output controller. A shared resource queue is associated with a plurality of ports. The shared resource queue includes a plurality of sections allocated for use by at least one of the plurality of ports based at least in part on a port bandwidth configuration of the plurality of ports.

### BACKGROUND

1. Field

Embodiments of the invention relate to the field of computer systems and more specifically, but not exclusively, to queue resource sharing for an input/output controller.

2. Background Information

Input/output (I/O) devices of a computer system often communicate with the system's central processing unit (CPU) and system memory via a chipset. The chipset may include a memory controller and an input/output controller. Devices of the computer system may be connected using various buses, such as a Peripheral Component Interconnect (PCI) bus.

A new generation of PCI bus, called PCI Express, has been promulgated by the PCI Special Interest Group. PCI Express uses high-speed serial signaling and allows for point-to-point communication between devices. Communications along a PCI Express connection are made using packets. Interrupts are also made using packets by using the Message Signal Interrupt scheme.

Current implementations assign dedicated resources to each PCI Express port of an I/O controller.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating one embodiment of an environment to support queue resource sharing in accordance with the teachings of the present invention.

FIG. 2A is a block diagram illustrating one embodiment of an environment to support queue resource sharing in accordance with the teachings of the present invention.

FIG. 2B is a block diagram illustrating one embodiment of an environment to support queue resource sharing in accordance with the teachings of the present invention.

FIG. 3 is a block diagram illustrating one embodiment of an environment to support queue resource sharing in accordance with the teachings of the present invention.

FIG. 4A is a block diagram illustrating one embodiment of an environment to support queue resource sharing in accordance with the teachings of the present invention.

FIG. 4B is a block diagram illustrating one embodiment of an environment to support queue resource sharing in accordance with the teachings of the present invention.

FIG. 4C is a block diagram illustrating one embodiment of an environment to support queue resource sharing in accordance with the teachings of the present invention.

FIG. 5 is a block diagram illustrating one embodiment of an environment to support queue resource sharing in accordance with the teachings of the present invention.

FIG. 6 is a block diagram illustrating one embodiment of an environment to support queue resource sharing in accordance with the teachings of the present invention.

FIG. 7 is a flowchart illustrating one embodiment of the logic and operations to support queue resource sharing in accordance with the teachings of the present invention.

FIG. 8 is a block diagram illustrating one embodiment of an environment to support queue resource sharing in accordance with the teachings of the present invention.

FIG. 9 is a block diagram illustrating one embodiment of an environment to support queue resource sharing in accordance with the teachings of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

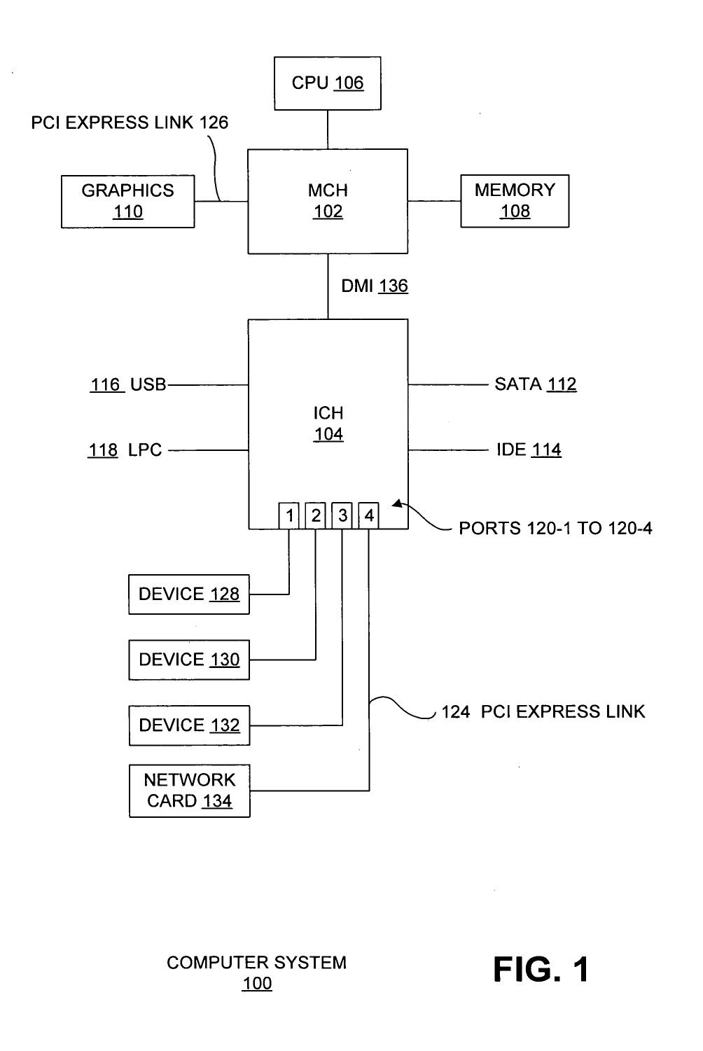

Referring to FIG. 1, one embodiment of a computer system 100 is shown. Embodiments of computer system 100 include, but are not limited to a desktop computer, a notebook computer, a server, a personal digital assistant, a network workstation, or the like. Computer system 100 includes an I/O controller, such as Input/Output Controller Hub (ICH) 104, coupled to a memory controller, such as Memory Controller Hub (MCH) 102. In one embodiment, ICH 104 is coupled to MCH 102 via a Direct Media Interface (DMI) 136. In one embodiment, ICH 104 includes an Intel® ICH6 family of I/O controllers.

A central processing unit (CPU) 106 and memory 108 is coupled to MCH 102. CPU 106 may include, but is not limited to, an Intel Pentium®, Xeon®, or Itanium® family processor, or the like. Memory 108 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. MCH 102 may also be coupled to a graphics card 110 via PCI Express link 126 (PCI Express discussed further below). In an alternative embodiment, MCH 102 may be coupled to an Accelerated Graphics Port (AGP) interface (not shown).

ICH 104 may include support for a Serial Advanced Technology Attachment (SATA) interface 112, an Integrated Drive Electronics (IDE) interface 114, a Universal Serial Bus (USB) 116, and a Low Pin Count (LPC) bus 118.

ICH 104 may also include PCI Express ports 120-1 to 120-4 that may operate substantially in compliance with the PCI Express Base Specification Revision 1.0a, Apr. 15, 2003. While the embodiment shown in FIG. 1 shows an I/O controller having four PCI Express ports, it will be understood that embodiments of the present invention are not limited to four ports. Further, it will be understood that embodiments herein are not limited to implementations using PCI Express.

Each port 120 is coupled to an add-in device via a PCI Express link, such as PCI Express link 124. In the embodiment of FIG. 1, port 120-1 is coupled to add-in device 128, port 120-2 is coupled to add-in device 130, port 120-3 is coupled to add-in device 132, and port 120-4 is coupled to a network card 134. In one embodiment, network card 134 includes an Ethernet Gigabyte card. Embodiments of an Add-in card include optical disk drive connectors, magnetic disk drive connectors, television tuners, modems, or the like.

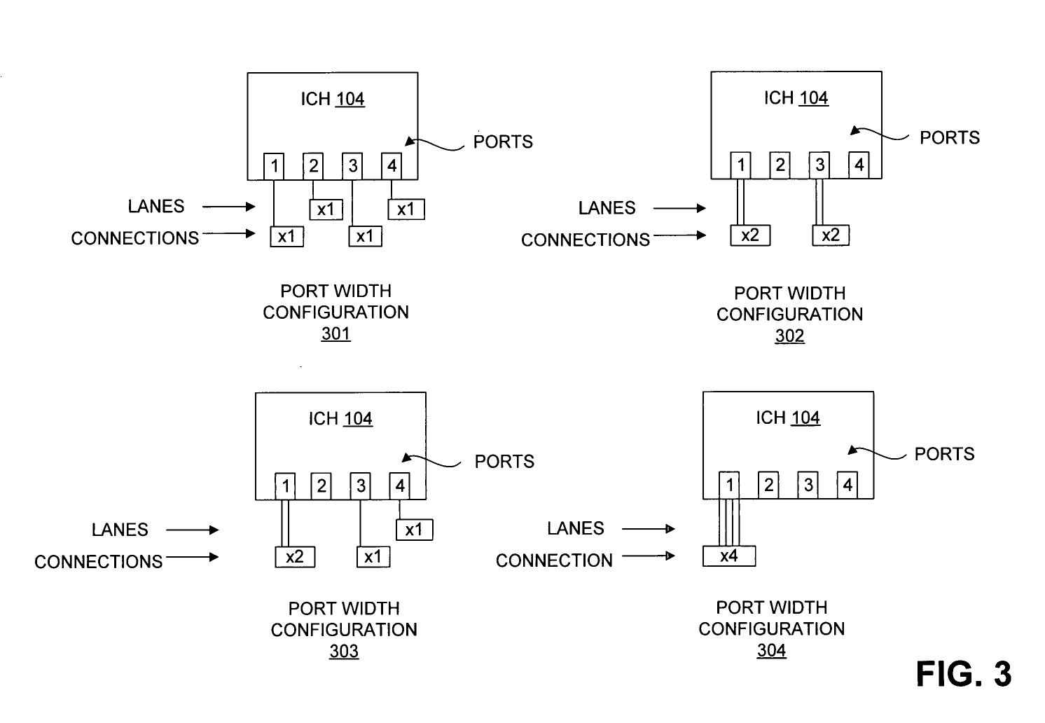

Alternative embodiments of computer system 100 may include other PCI Express port configurations (embodiments of port configurations are discussed below in conjunction with FIG. 3). In one embodiment, at least one PCI port 120 connects to a switch that may provide additional PCI Express ports.

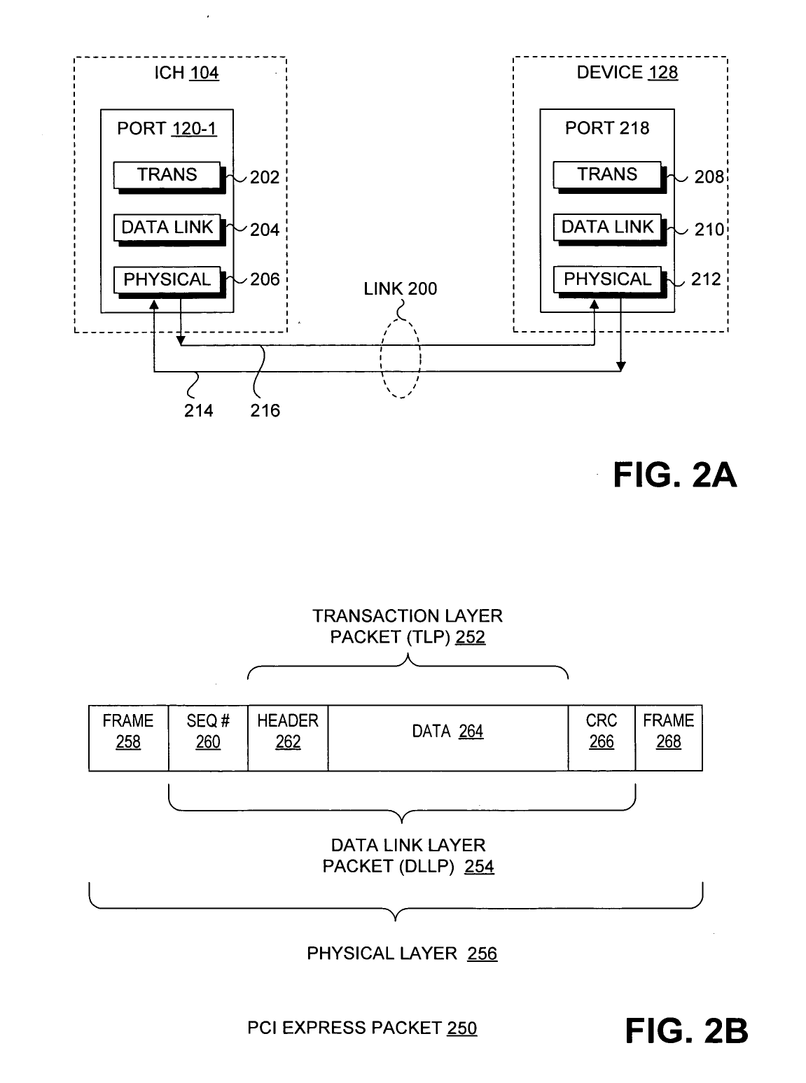

FIG. 2A shows ICH 104 coupled to Device 128 via PCI Express Link 200. Link 200 is a connection between port 120-1 of ICH 104 and port 218 of device 128. Link 200 includes a differential signal pair consisting of a receive pair 214 and a transmit pair 216, where transmit and receives is from the perspective of ICH 104.

Link 200 supports at least 1 lane. Each lane represents a set of differential signaling pairs, one pair for transmitting and one pair for receiving resulting in a total of 4 signals. A x1 link includes 1 lane. The width of link 200 may be aggregated using multiple lanes to increase the bandwidth of the connection between ICH 104 and device 128. In one embodiment, link 200 may include a x1, x2, and x4 link. Thus, a x4 link includes 4 lanes. In other embodiments, link 200 may provide up to a x32 link. In one embodiment, a lane in one direction has a rate of 2.5 Gigabits per second.

FIG. 2A also shows the logic layers of an embodiment of the PCI Express architecture. ICH 104 includes a Transaction Layer 202, a Data Link Layer 204, and a Physical Layer 206. Device 128 includes a corresponding Transaction Layer 208, Data Link Layer 210, and Physical Layer 212.

Information between devices is communicated using packets. FIG. 2B shows an embodiment of PCI Express packet 250. To send a packet, the packet is started at the Transaction Layer and passed down to the Physical Layer. The packet is received at the Physical Layer of the receiving device and passed up to the Transaction Layer. The packet data is extracted from the packet at the receiving device.

In general, the Transaction Layer assembles and disassembles Transaction Layer Packets (TLPs), such as TLP 252. TLP 252 includes a header 262 and data 264. TLPs may be used to communicate read and write transactions. TLPs may also include command functions, such as an interrupt.

The Data Link Layer serves as an intermediate stage between the Transaction Layer and the Physical Layer. The Data Link Layer may perform link management and data integrity verification. The Data Link Layer creates a Data Link Layer Packet (DLLP) 254 by adding a sequence number 260 and a Cyclic Redundancy Check (CRC) 266 for transmission. On the receive side, the Data Link Layer checks the integrity of packet 250 using CRC 266. If the receiving Data Link Layer detects an error, the Data Link Layer may request that the packet be re-transmitted.

The Physical Layer takes information from the Data Link Layer and transmits a packet across the PCI Express link. The Physical Layer adds packet framing 258 and 268 to indicate the start and end of packet 250. The Physical Layer may include drives, buffers, and other circuitry to interface packet 250 with link 200.

Referring to FIG. 3, embodiments of port width configurations are shown. In the embodiments of FIG. 3, ICH 104 has four ports 1-4 and 4 lanes. The 4 lanes may be allocated among the ports as described below based on the port width configuration. In one embodiment, the configuration of ports 1-4 are designated at the power up of ICH 104 by configuration registers, also known as boot strap registers. In one embodiment, an Original Equipment Manufacturer (OEM) may set the configuration registers during assembly of the computer system.

In port width configuration 301, port 1 uses lane 1, port 2 uses lane 2, port 3 uses lane 3, and port 4 uses lane 4. Configuration 301 results in four x1 connections for devices.

In port width configuration 302, port 1 uses lanes 1 and 2. Port 2 is disabled. Port 3 uses lanes 3 and 4. Port 4 is disabled. Configuration 302 results in two x2 connections.

In port width configuration 303, port 1 uses lanes 1 and 2. Port 2 is disabled. Port 3 uses lane 3 and port 4 uses lane 4. Configuration 303 results in one x2 and two x1 connections.

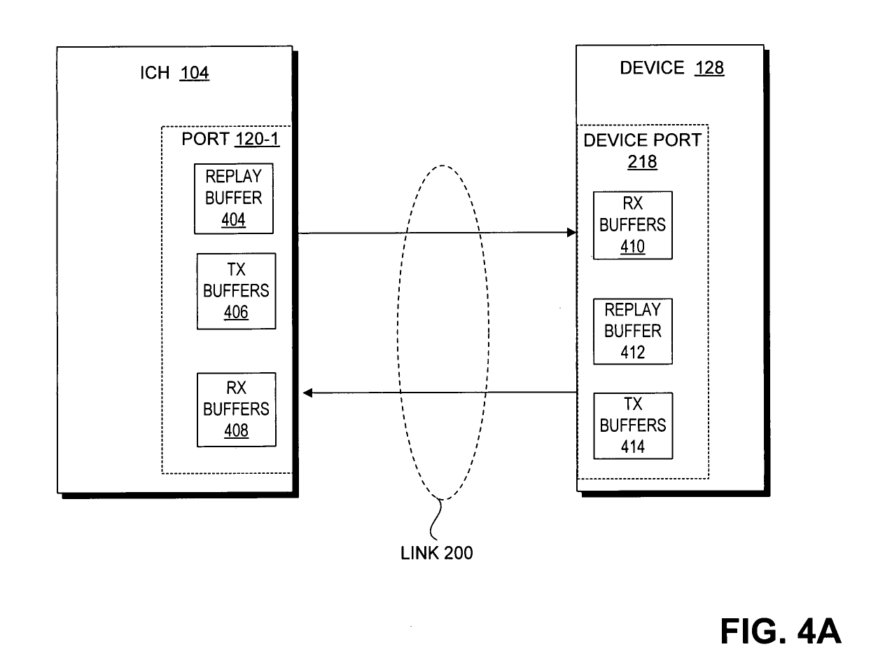

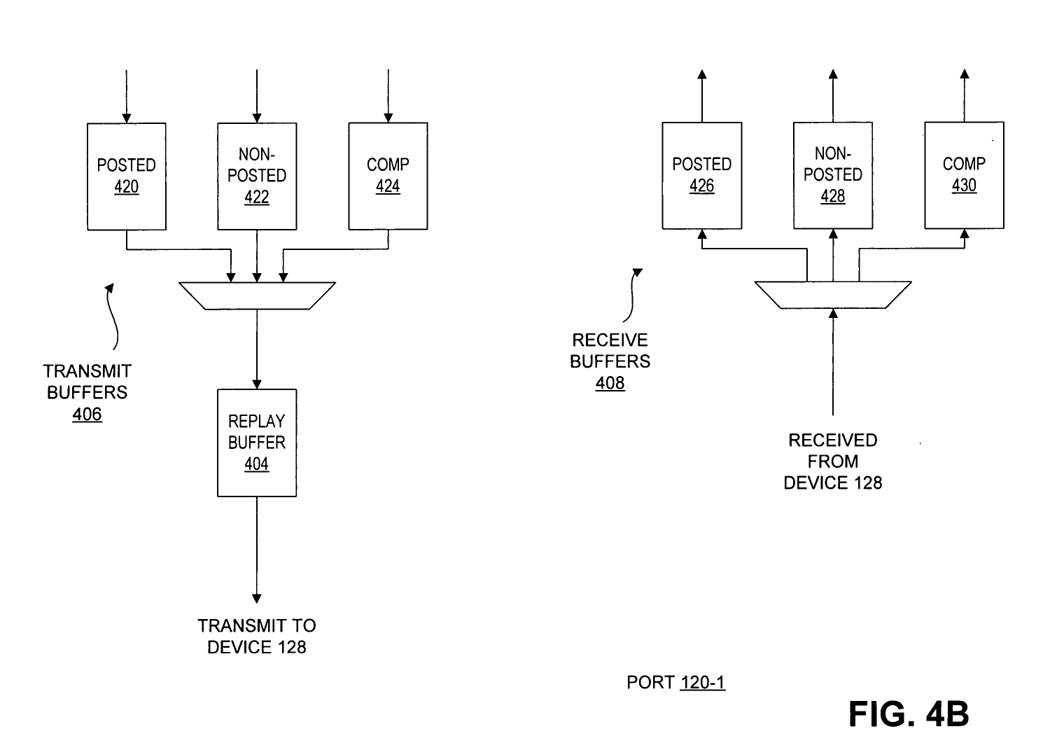

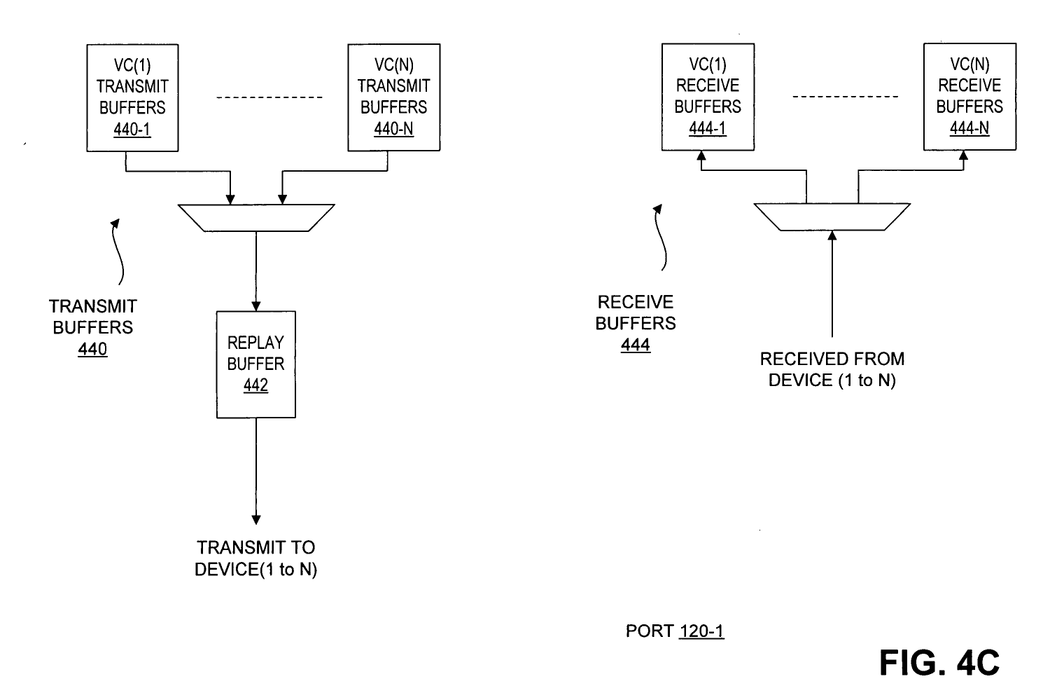

In port width configuration 304, port 1 uses lanes 1-4. Ports 2-4 are disabled. Thus, configuration 304 results in one x4 connection. Turning to FIG. 4A, an embodiment of buffers associated with port 120-1 and a device port 218 of device 128 are shown. The buffers are used to manage TLPs on the Transaction Layer of the ports. ICH 104 is coupled to device 128 via link 200. The transmit side of port 120-1 has associated replay buffer 404 and transmit (TX) buffers 406. The receive side of port 120-1 has associated receive (RX) buffers 408. Embodiments herein teach sharing a buffer among all ports 120, instead of assigning dedicated buffers to each port 120 of ICH 104.

Device port 218 has associated receive buffers 410 as well as replay buffer 412 and transmit buffers 414.

Turning to FIG. 4B, embodiments of transmit buffers 406, replay buffer 404, and receive buffers 408 associated with port 120-1 are shown. In general, transmit buffers 406 are used to hold transaction layer packets that are to be transmitted from ICH 104. Receiver buffers 408 hold TLPs received from device 128. In one embodiment, these received TLPs are forwarded to the CPU and memory for processing.

Transmit buffers 406 include posted buffer 420, non-posted buffer 422, and completions buffer 424. Posted buffer 420 holds TLPs that do not require a reply from the receiver, such as a write transaction. Non-posted buffer 422 holds TLPs that may require a reply from the receiver, such as a read request.

Completions buffer 424 holds TLPs that are to be transmitted to device 128 in response to non-posted TLPs received from device 128. For example, ICH 104 may receive a read request (non-posted transaction) from device 128. The requested information is retrieved from memory and provided to ICH 104. The retrieved information is formed into one or more TLPs that may be placed in completions buffer 424 awaiting transmission to device 128.

Replay buffer 404 is used to maintain a copy of all transmitted TLPs until the receiving device acknowledges reception of the TLP. Once the TLP has been successfully received, that TLP may be removed from the Replay buffer 404 to make room for additional TLPs. If an error occurs, then the TLP may be re-transmitted from Replay buffer 404.

Receive buffers 408 include posted buffer 426, non-posted buffer 428, and completions buffer 430. Receive buffers 408 store the received TLPs until the receiving device is ready to act on the received packets.

Turning to FIG. 4C, an embodiment of virtual channels in accordance with one embodiment of the present invention is shown. In short, numerous independent communications sessions may occur in a single lane through virtual channels. Traffic Class labeling is used to differentiate packets from among the virtual channels. In the embodiment of FIG. 4C, port 120-1 is supporting virtual channels (VCs) 1 to N. Virtual Channels 1-N are used to communicate with corresponding devices 1 to N.

Transmit buffers 440 include VC(1) Transmit Buffers 440-1 to VC(N) Transmit Buffers 440-N. Port 120-1 has associated a single Replay buffer 442. Receive buffers 444 include VC(1) Receive Buffers 444-1 to VC(N) Receive Buffers 444-N. Each VC Transmit and VC Receive Buffer may include posted, non-posted, and completions buffers as described above in conjunction with FIG. 4B.

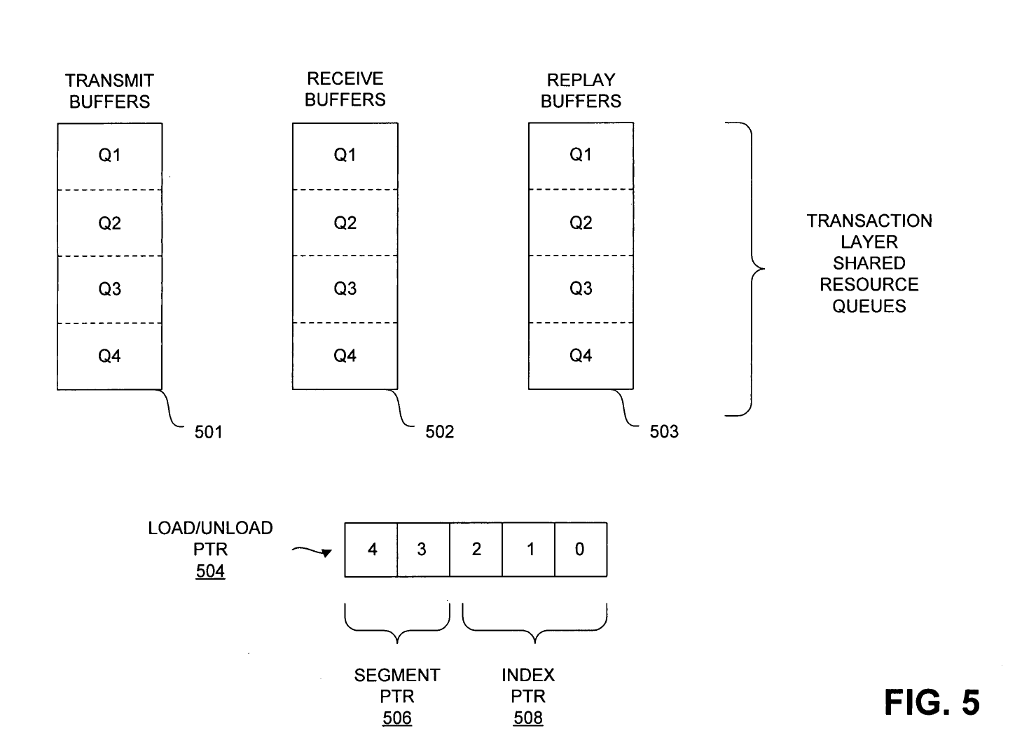

Turning to FIG. 5, one embodiment of an environment to support queue resource sharing is shown. FIG. 5 shows an embodiment of transaction layer shared resource queues 501, 502, and 503. Queue 501 corresponds to transmit buffers, queue 502 corresponds to receive buffers, and queue 503 corresponds to replay buffers. Each shared resource queue 501-503 is divided into four quarters Q1-Q4. As will be described further below, a queue is allocated for use by the ports of ICH 104 based on the port width configuration of the ports. In general, the greater the port width, the greater amount of a queue is allocated to the port. In one embodiment, each quarter of queues 501-503 includes 8 entries.

FIG. 5 also shows an embodiment of a load pointer (or unload pointer) 504. Pointer 504 is five bits long (bits 0 to 4). Pointer 504 may include a segment pointer 506 and an index pointer 508. The segment pointer 506 is used to identify the quarter of the queue that is being addressed by the load/unload pointer 504. Index pointer 508 is used to address a particular entry within the quarter identified by the segment pointer 506. In the embodiment of FIG. 5, index pointer 508 includes 3 bits, so index pointer may address up to 8 entries in each quarter.

Further, it will be understood that embodiments of load and unload pointers are not limited to five bits, as shown in FIG. 5. A segment pointer may be more or less than two bits. Since embodiments of ICH 104 are not limited to 4 ports, it follows that embodiments of a shared resource queue are not limited to a division into 4 quarters. For example, if ICH 104 has 8 x1 ports, then a shared resource queue may be divided into 8 sections, one for each port. Continuing in this example, the segment pointer width may be expanded to 3-bits [2:0] to provide addressing of the 8 sections.

In other embodiments, an index pointer may be more or less than three bits if the size of a quarter is more or less than 8 entries. For example, the index pointer may be 4 bits wide [3:0] for 16 entries per quarter, or in another example, the index pointer may be 5 bits wide [4:0] for 32 entries per quarter. In other embodiments, the number of entries of a quarter does not have to correspond to a binary based number (discussed further below).

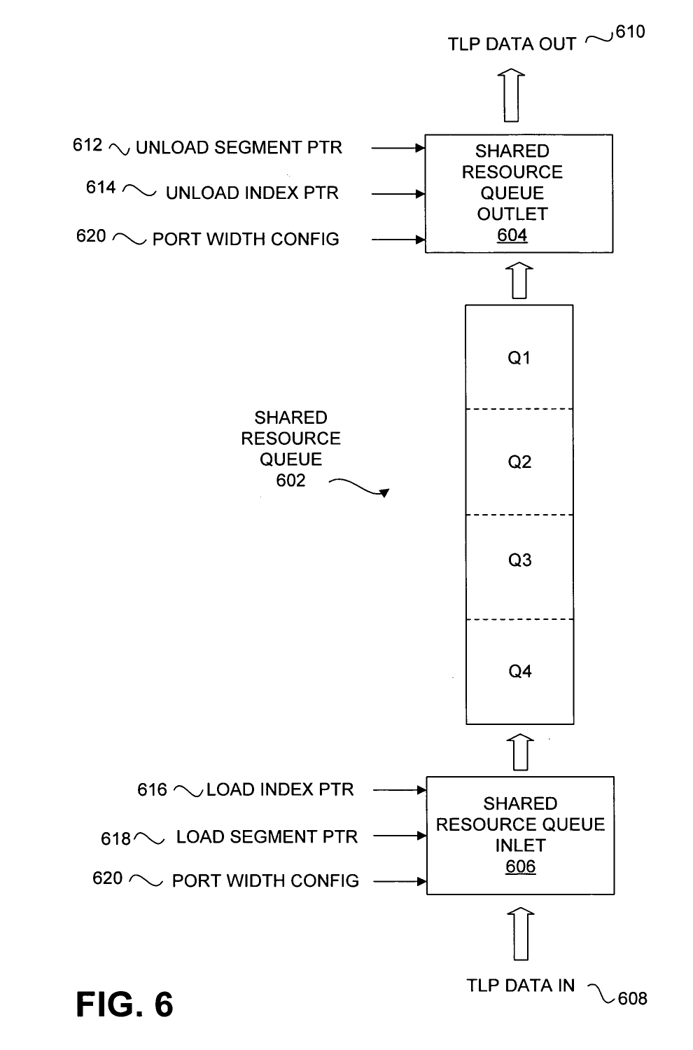

Referring to FIG. 6, an embodiment of a shared resource queue 602 is shown. Queue 602 includes four quarters Q1 to Q4. Queue 602 may be used for transmit buffers, receive buffers, or replay buffers of ICH 104. The allocation of the quarters of queue 602 to ports 120-1 to 120-4 is determined by the port width configuration of ICH 104.

Referring again to FIG. 3, for port width configuration 301, each port is allocated a single quarter. For port width configuration 302, port 1 is assigned two quarters and port 3 is assigned two quarters. In port width configuration 303, port 1 is allocated two quarters, while ports 3 and 4 are each allocated a single quarter. For port width configuration 304, all four quarters of queue 602 are allocated to port 1.

A shared resource queue inlet 606 and a shared resource queue outlet 604 are coupled to queue 602. Shared resource queue inlet 606 receives load index pointer 616 and load segment pointer 618 for processing of TLP data received at TLP data in 608. Load segment pointer 618 identifies the quarter selected for loading of the data, and load index pointer 616 identifies the entry within the quarter for loading the data. Shared queue resource inlet 606 also receives port width configuration 620 to be used for identifying the selected quarter and its entry for loading of TLP data.

Shared resource queue outlet 604 receives unload segment pointer 612 and unload index pointer 614. Shared resource queue outlet 604 also receives port width configuration 620. Outlet 604 uses pointers 612 and 614, and the port width configuration 620, to determine which quarter and entry to unload data from to a particular port. The data is outputted from shared resource queue outlet 604 at TLP data out 610 to the designated port.

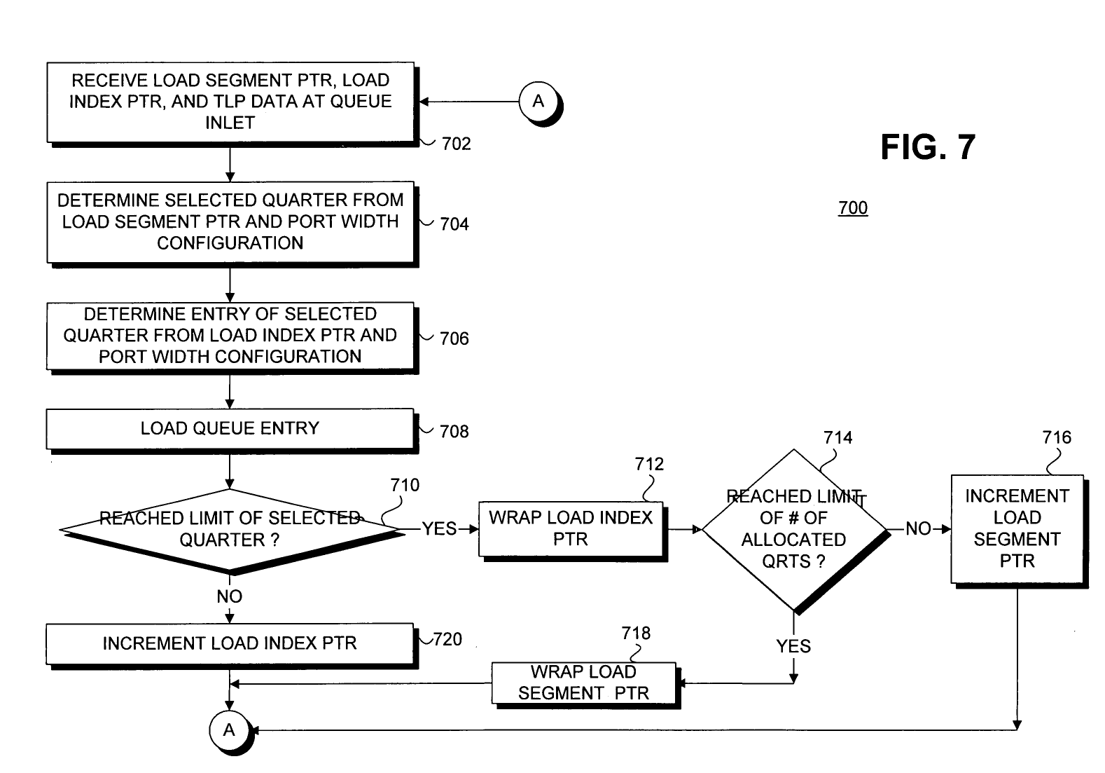

Turning to FIG. 7, an embodiment of a flowchart 700 to provide queue resource sharing is shown. Flowchart 700 shows the logic and operations for loading a shared resource queue. One skilled in the art will understand that unloading a shared resource queue may operate in a similar manner. In one embodiment, the logic of flowchart 700 may be implemented as hardware gates and other circuitry of ICH 104.

Starting in a block 702, a load segment pointer, a load index pointer, and TLP data is received at a shared resource queue inlet. Proceeding to a block 704, the selected quarter of the shared resource queue is determined from the load segment pointer and the port width configuration. The port width configuration indicates how the quarters of the shared resource queue are allocated to the ports.

Continuing to a block 706, the entry within the selected quarter is determined from the load index pointer and the port width configuration. In a block 708, the queue entry is loaded with the received TLP data.

Proceeding to a decision block 710, the logic determines if the limit of the selected quarter has been reached. If the answer to decision block 710 is no, then the logic proceeds to a block 720 to increment the load index pointer. This increment of the index pointer sets the index pointer to the next available entry for loading of TLP data. The logic then returns to block 702.

If the answer to decision block 710 is yes, then the logic proceeds to a block 712 to wrap the load index pointer to the start of the selected quarter. Continuing to a decision block 714, the logic determines if the limit of the number of allocated quarters has been reached. If the answer to decision block 714 is yes, then the logic continues to a block 718 to wrap the segment pointer. The logic then returns to block 702.

If the answer to decision block 714 is no, then the logic continues to a block 716 to increment the load segment pointer. The logic then returns to block 702.

As an example of wrapping the index pointer and segment pointer, consider port width configuration 303. For this example, assume Q1 and Q2 are allocated to port 1, while Q3 and Q4 are allocated to ports 3 and 4, respectively. The segment pointer of Q1 starts at 00b (where “b” indicates a binary number). The Q1 segment pointer increments to 01b when the end of Q1 is reached. This segment pointer wraps around to 00b after the end of Q2 is reached because port 1 has a two quarter address limit. However, the segment pointer of port 3 always stays at 00b because it has a one quarter address limit. It will be understood that in block 718 for port 3, the segment pointer wraps by staying at 00b. The segment pointer of port 4 operates in a substantially similar manner as the segment pointer of port 3.

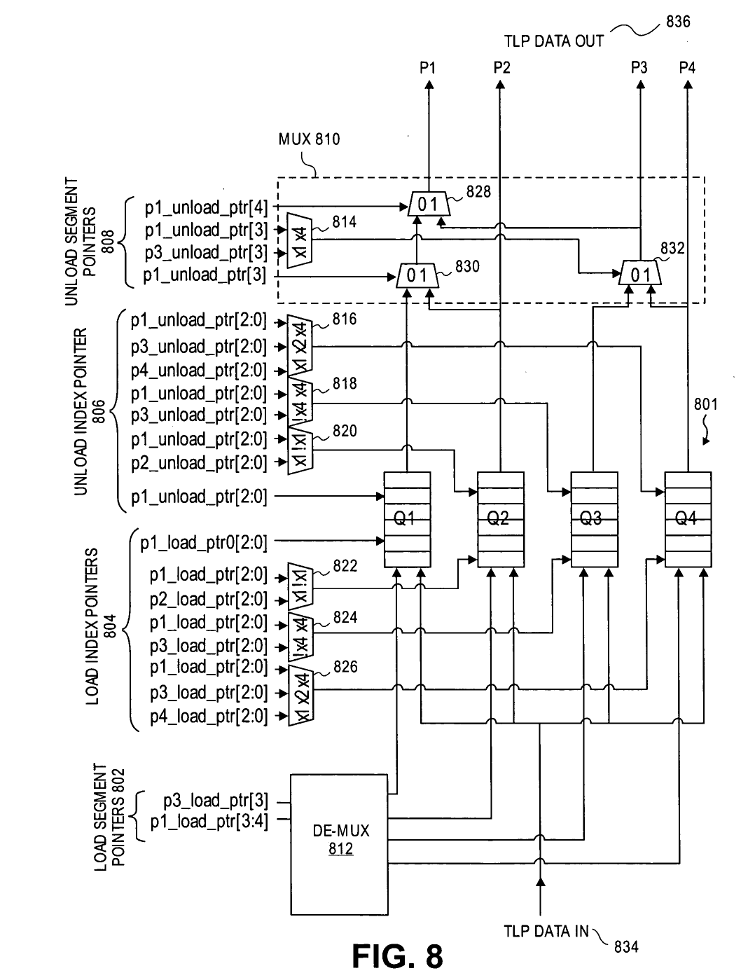

Referring to FIG. 8, an embodiment of an environment to support queue resource sharing in accordance with the teachings of the present invention is shown. A shared resource queue 801 is shown divided into four quarters Q1 to Q4. Shared resource queue 801 receives load segment pointers 802, load index pointers 804, and data from TLP data in 834. Shared resource queue 801 also receives unload segment pointers 808 and unload index pointers 806 for unloading TLP data at TLP data out 836. TLP data out 836 includes four outputs P1 to P4 corresponding to each port of ICH 104.

Port width configuration information is provided to various multiplexers when handling the load and unload pointers. In one embodiment, this port width configuration information acts as select inputs to the multiplexers. These multiplexers will be described below using examples of various port width configurations. It will be understood that the use of “!” in FIG. 8 refers to a logical “NOT”. Further, the notation “ptr[X]” in FIG. 8 refers to bit position(s) X of the pointer.

An example of operations by the embodiment of FIG. 8 will be discussed using port width configuration 301. In configuration 301, each port 1-4 is assigned to Q1-Q4, respectively. All the segment pointers will remain at 00b. As shown in FIG. 8, load and unload index pointers for P1 always point to Q1.

At multiplexer (mux) 816, since port 4 is in a x1 configuration, the port 4 unload index pointer, shown as p4_unload_ptr[2:0], is passed to Q4. Since port 3 is not in a x2 configuration and port 1 is not in a x4 configuration, these unload index pointers are not passed through mux 816.

At mux 818, port 3 unload index pointer, shown as p3_unload_ptr[2:0], goes to Q3 since port 3 is not in a x4 configuration. At mux 820, since port 2 is in a x1 configuration, port 2's unload index pointer, p2_unload_ptr[2:0], is passed to Q2.

Continuing with this port width configuration 301 example, the unload segment pointers 808 will now be discussed. The logic of the unload segment pointers is grouped into a single mux 810. Corresponding logic for the load segment pointers 802 is provided in de-mux 812.

Since ports 1-4 are all in a x1 configuration, all their segment pointers remain at value 00b. The data from Q2 is always sent to P2 and data from Q4 is always sent to P4, as shown at TLP data out 836. P1_unload_ptr[3] and p3_unload_ptr[3] are inputted into mux 814. Since port 3 is in a x1 configuration, the p3_unload_ptr[3] is passed to mux 832. Since the value of p3_unload_ptr[3] is 0b, Q3 data is sent to P3 of TLP data out 836.

Also the output of mux 832 is inputted to mux 828. Since p1_unload_ptr[4] is 0b, the output of mux 830 is selected. Mux 830 outputs Q1 data since the value of p1_unload_ptr[3] is 0b. Thus, Q1 data is sent to P1.

Turning to the load portion of FIG. 8, one skilled in the art will appreciate that load index pointers 804 and muxes 822, 824, and 826 operate in a similar way as unload index pointers 806 discussed above. Also, one skilled in the art will appreciate that de-mux 812 may include logic similar to mux 810 to operate in a similar fashion.

In another example, port width configuration 304 will be used. In this configuration, all 4 lanes are assigned to port 1 and ports 2-4 are disabled. Thus, Q1-Q4 are allocated for use by port 1. Port 1 unload index pointer is sent directly to Q1. At mux 820, port 1 unload index pointer, shown as p1_unload_ptr[2:0] is passed to Q2 since port 1 is not in a x1 configuration. At mux 818, port 1 unload index pointer is passed to Q3 since port 1 is in a x4 configuration. At mux 816, the port 1 unload index pointer is passed to Q4 since port 1 is in a x4 port width configuration.

An embodiment of the incrementing of segment and index pointers for configuration 304 may be summarized as follows. The unload segment pointer of port 1, p1_unload_ptr[3:4], may start at 00b and work through Q1. At the end of Q1, the index pointer wraps around, and the segment pointer may advance to 01b to start unloading from Q2. The index pointer advances and wraps around again, while the segment pointer advances to 10b for Q3. At the end of Q3, the index pointer wraps around, and the segment pointer advances to 11b for Q4. At the end of Q4, the index pointer and the segment pointer wrap around to a value of 0.

Referring to FIG. 8, when port 1 unload segment pointer is 00b, the logic of mux 810 causes data from Q1 to be outputted to P1. At mux 830, p1_unload_ptr[3] selects Q1, and at mux 828, p1_unload_ptr[4] selects Q1 data from mux 830.

When the port 1 unload segment pointer is 01b, data from Q2 is sent to P1. At mux 830, p1_unload_ptr[3] selects Q2, and at mux 828, p1_unload_ptr[4] selects Q2 data from mux 830.

When port 1 unload segment pointer is 10b, data from Q3 is sent to P1. Mux 832 outputs Q3 data since the value of p1_unload_ptr[3] from mux 814 is 0b. Mux 828 then forwards Q3 data to P1 of TLP data out 836 since p1_unload_ptr[4] is 1b.

When port 1 unload segment pointer is 11b, data from Q4 is sent to P1. Q4 data is forwarded by mux 832 since p1_unload_ptr[3] from mux 814 is 1b. This Q4 data is forwarded by mux 828 to P1 since p1_unload_ptr[4] is 1b.

The load index pointers 804 and load segment pointers 802 operate in a similar fashion in port width configuration 304. From the above two examples, one skilled in the art will appreciate the operation of the embodiment of FIG. 8 when applied to port width configurations 302 and 303.

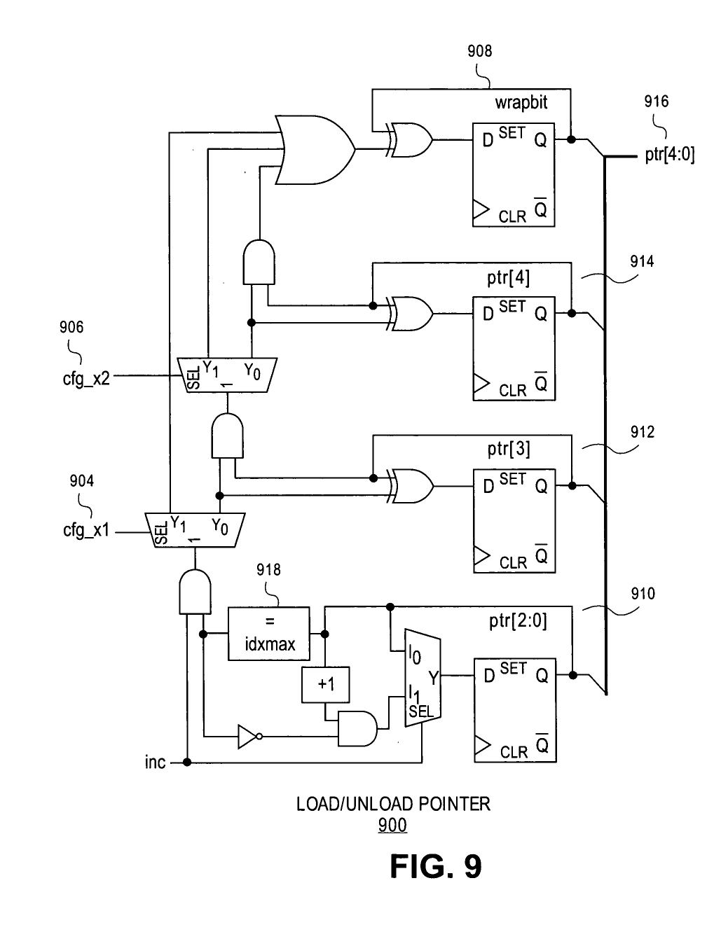

Turning to FIG. 9, an embodiment of load/unload pointer 900 is shown. The embodiment of 900 may be used to implement a load pointer or an unload pointer in accordance with embodiments described herein. Ptr[2:0] shown at 910 is the index pointer, and ptr[3] at 912 and ptr[4] at 914 make up the segment pointer. The aggregate of the index and segment pointers is outputted as ptr[4:0] shown at 916.

The index pointer counts up until the index pointer reaches its maximum value, stored at 918. In one embodiment, the maximum value corresponds to the number of entries of a quarter of the shared resource queue.

In one embodiment, the depth of a quarter may not be a binary depth, such as 2, 4, 8, etc. The embodiment of FIG. 9 provides for non-power of 2 quarter sections of the shared queues. The quarter queue depth may correspond to the index maximum value stored at 918. When the index pointer reaches the specified index maximum value stored at 918, the index pointer will wrap over and clear to zero. For example, if the index pointer width is 3 bits [2:0] and the quarter queue depth is 6 entries, then the maximum index value stored at 918 would be 101b for entries 0 to 5. When the index pointer reaches 101b and there is another data load into the queue, then the index pointer will wrap over to 000b.

The configuration of the port associated with pointer 900 is indicated by cfg_x1 input shown at 904 and the cfg_x2 input shown at 906. If neither cfg_x1 nor cfg_x2 is set to “1”, then it is assumed that the port is in a x4 configuration. The setting of the configuration allows for the segment pointer (ptr[3] and ptr[4]) to be incremented accordingly.

A wrap bit 908 is used to determine if the quarter associated with the load and unload pointers is empty or full. In one embodiment, if the segment and index values of the load pointer and the unload pointer are the same value, and if the wrap bit of both load and unload pointers are equal, then this is an empty condition of the quarter. If the wrap bit of both load and unload pointers are not equal, then this is a full condition of the quarter.

Embodiments as described herein provide for queue resource sharing for an I/O controller. Instead of having dedicated queues at each port of the ICH, embodiments herein provide a single queue that may be shared by multiple ports. This may result in a lower gate count and smaller die area than used by port-dedicated resources. Further, embodiments herein provide shared queue resources for I/O controllers having multiple port width configurations.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

What is claimed is:

1. An apparatus, comprising:
a plurality of ports; and
a shared resource queue associated with the plurality of ports, wherein the shared resource queue includes a plurality of sections allocated for use by at least one of the plurality of ports based at least in part on a port bandwidth configuration of the plurality of ports.

2. The apparatus of claim 1 wherein the apparatus includes an input/output controller.

3. The apparatus of claim 1, further comprising:
a shared resource queue inlet coupled to the shared resource queue, the shared resource queue inlet to determine an entry of a selected section to load with data based at least in part on a load pointer received at the shared resource queue inlet; and
a shared resource queue outlet coupled to the shared resource queue, the shared resource queue to determine an entry of a selected section to unload data from based at least in part on an unload pointer received at the shared resource queue outlet.

4. The apparatus of claim 1 wherein a first port of the plurality of ports to be allocated more sections of the shared resource queue than a second port of the plurality ports, wherein a first port bandwidth is greater than a second port bandwidth.

5. The apparatus of claim 1 wherein the plurality of ports operate substantially in compliance with a PCI (Peripheral Component Interconnect) Express specification.

6. An input/output controller, comprising:
four PCI (Peripheral Component Interconnect) Express ports; and
a shared resource queue associated with the four PCI Express ports, wherein the shared resource queue includes four quarters allocated for use by at least one of the four PCI Express ports based at least in part on a port width configuration of the four PCI Express ports.

7. The input/output controller of claim 6 wherein the shared resource queue includes one of a transmit buffer, a receive buffer, and a replay buffer associated with a first PCI Express port of the four PCI Express ports.

8. The input/output controller of claim 7 wherein the transmit buffer includes a plurality of virtual channel transmit buffers to support a corresponding plurality of virtual channels supported by the first PCI Express port.

9. The input/output controller of claim 6, further comprising:
a shared resource queue inlet coupled to the shared resource queue, wherein the shared resource queue inlet to load transaction layer packet data based at least in part on a load pointer received at the shared resource queue inlet, the load pointer to indicate which entry of the shared resource queue to load with the transaction layer packet data; and
a shared resource queue outlet coupled to the shared resource queue, wherein the shared resource queue outlet to unload transaction layer packet data based at least in part on an unload pointer received at the shared resource queue outlet, the unload pointer to indicate which entry of the shared resource queue to unload the transaction layer packet data from.

10. The input/output controller of claim 9 wherein the load pointer comprises:
a load segment pointer to indicate a selected quarter of the four quarters to load with the transaction layer packet data; and
a load index pointer to indicate the entry of the selected quarter to load with the transaction layer packet data,
and wherein the unload pointer comprises:
an unload segment pointer to indicate a selected quarter of the four quarters to unload the transaction layer packet data from; and
an unload index pointer to indicate the entry of the selected quarter to unload the transaction layer packet data from.

11. The input/output controller of claim 10 wherein the shared resource queue inlet comprises:
a demultiplexer coupled to each quarter of the shared resource queue, the demultiplexer to select the selected quarter based on the load segment pointer and the port width configuration of the input/output controller; and
at least one multiplexer coupled to each quarter of the shared resource queue, the at least one multiplexer to select the entry of the selected quarter based on the load index pointer and the port width configuration of the input/output controller.

12. The input/output controller of claim 10 wherein the shared resource queue outlet comprises:
a multiplexer coupled to each quarter of the shared resource queue, the multiplexer to select the selected quarter based on the unload segment pointer and the port width configuration of the input/output controller; and
at least one multiplexer coupled to each quarter of the shared resource queue, the at least one multiplexer to select the entry of the selected quarter based on the unload index pointer and the port width configuration of the input/output controller.

13. The input/output controller of claim 10 wherein the load index pointer and the unload index pointer provide for a non-binary depth of a quarter of the shared resource queue.

14. The input/controller of claim 10 wherein a circuit to support the load pointer includes a wrap bit to determine if the selected quarter is full or empty.

15. A method, comprising:
receiving a load pointer at a shared resource queue, wherein the shared resource queue is allocated between a plurality of ports of an input/output controller based on the port width configuration of the input/output controller;
determining which entry of the shared resource queue is indicated by the load pointer and the port width configuration; and
loading an entry of the shared resource queue with data associated with a port of the plurality of ports.

16. The method of claim 15 wherein determining which entry of the shared resource queue is indicated by the load pointer comprises:
determining which quarter of the shared resource queue is selected by a load segment pointer of the load pointer; and
determining which entry of the selected quarter is indicated by a load index pointer of the load pointer.

17. The method of claim 15 wherein the shared resource queue is associated with one of a transmit buffer, a receive buffer, and a replay buffer of a first port of the plurality of ports.

18. The method of claim 15 wherein the data includes transaction layer packet data and wherein the plurality of ports includes a plurality of PCI (Peripheral Component Interconnect) Express ports.

19. The method of claim 15, further comprising:
incrementing the load index pointer if the end of the selected quarter has not been reached; and
wrapping the load index pointer if the end of the selected quarter has been reached.

20. The method of claim 15, further comprising:
incrementing the load segment pointer if the limit of the number of quarters allocated to the port has not been reached; and
wrapping the load segment pointer if the limit of the number of quarters allocated to the port has been reached.

21. The method of claim 15, further comprising:
receiving an unload pointer at the shared resource queue;
determining which entry of the shared resource queue is indicated by the unload pointer and the port width configuration; and
unloading data stored at an entry of the shared resource queue to the port.

22. A system, comprising:
a network card;
an input/output controller coupled to the network card via a PCI (Peripheral Component Interconnect) Express link, wherein the input/output controller includes:
four PCI Express ports, wherein a first port of the four PCI Express ports is coupled to the network card via the PCI Express link; and
a shared resource queue associated with the first port, wherein the shared resource queue includes four quarters, the number of quarters allocated for use by the first port based at least in part on the port width configuration of the input/output controller.

23. The system of claim 22 wherein the input/output controller includes:
a shared resource queue inlet coupled to the shared resource queue, wherein the shared resource queue inlet to load transaction layer packet data based at least in part on a load pointer received at the shared resource queue inlet, the load pointer to indicate which entry of the shared resource queue to load with the transaction layer packet data; and
a shared resource queue outlet coupled to the shared resource queue, wherein the shared resource queue outlet to unload transaction layer packet data to the first port based at least in part on an unload pointer received at the shared resource queue outlet, the unload pointer to indicate which entry of the shared resource queue to unload the transaction layer packet data from.

24. The system of claim 23 wherein the shared resource queue inlet to determine which entry to load with transaction layer packet data based at least in part on the port width configuration of the input/output controller, and wherein the shared resource queue outlet to unload transaction layer packet data to the first port based at least in part on the port width configuration of the input/output controller.

25. The system of claim 22 wherein the PCI Express link includes one of a x1 link, a x2 link, and a x4 link.
